(19) United States
(12) Patent Application Publication
(10) Pub. No.: US 2015/0015011 A1
(43) Pub. Date: Jan. 15, 2015

(54) SYSTEM AND METHODS FOR RETRIEVAL OF GOLF DISCS

(71) Applicant: Christopher Joseph Silva, Seekonk, MA (US)

(72) Inventor: Christopher Joseph Silva, Seekonk, MA (US)

(21) Appl. No.: 13/941,511

(22) Filed: Jul. 14, 2013

(51) Int. Cl. B25J 1/04

(52) U.S. Cl. CPC B25J 1/04
USPC 294/104

(57) ABSTRACT

Disclosed herein are systems, devices, and methods for retrieving objects, and in particular, golf discs, at a distance beyond arm's reach. The retrieval systems and devices described herein are easily and quickly assembled and disassembled, and then readily fit into or on a disc golf bag or other sack or back pack. The systems, devices, and methods provide a clamping golf disc retriever for the retrieval of golf discs that are otherwise beyond reach. In certain approaches, the systems, devices, and methods described herein may include one or more multi-member extendable poles that can expand to achieve a length greater than the compacted length and an attaching gripping or clamping device whose jaws are employed to obtain a secure, positive, firm ensnarement of the golf disc.

### BACKGROUND

Disc golf has gained significant popularity in America and other countries, and the number of players and courses continues to grow. During the game of disc golf, players attempt to throw the disc through a course into a basket, often called a goal. A disc golf course typically includes a number of primary obstacles on the path to the goal. These include, but are not limited to, water hazards, trees, bushes, and briar patches. Similar hazards are also common just outside the fairway or primary playing areas of the course. During play, discs often land in these obstacles or hazards. Many times, a golf disc that lands in an obstacle is unreachable by hand. A player may abandon a disc on the course due to the difficulty of retrieving it, even when the disc is plainly visible. However, golf discs are expensive and non-biodegradable. Golf discs can also have specific, unique, predictable flight qualities that are desired, known, and prized by the owner. For these and other reasons, a player is very likely to want to retrieve the disc. Players often resort to ad hoc solutions to retrieving a disc, such as using a stick or rock to knock down a disc, wading into a water hazard, or climbing into a tree or through bushes. These attempts are often unsuccessful, and in some cases result in discomfort or even injury. Accordingly, compact and easy to use retrieval systems for obtaining discs beyond arm's reach may be beneficial for disc golf and other applications.

### SUMMARY

Disclosed herein are systems, devices, and methods for retrieving objects, and in particular, golf discs, at a distance beyond arm's reach. The retrieval systems and devices described herein are easily and quickly assembled and disassembled, and then readily fit into or on a disc golf bag or other sack or back pack. The systems, devices, and methods provide a clamping golf disc retriever for the retrieval of golf discs that are otherwise beyond reach. In certain approaches, the systems, devices, and methods described herein may include one or more multi-member extendable poles that can expand to achieve a length greater than the compacted length and an attaching gripping or clamping device whose jaws are employed to obtain a secure, positive, firm ensnarement of the golf disc.

In certain aspects, the systems, methods, and devices include a retrieval system having a first jaw with a first distal grip end, and a second jaw with a second distal grip end. The second jaw is coupled to the first jaw with a first pivot joint at a position proximal to the first distal grip end and proximal to the the second distal grip. The systems, methods, and devices include a compression device coupled to the first jaw and the second jaw. The compression device is configured to apply a closing force between the first jaw and the second jaw. In certain approaches, the retrieval system includes a seating pin coupled to the second jaw. In certain embodiments, the retrieval system includes a latch. The latch has a pivot portion rotatably coupled to a second pivot joint at the first jaw, and a seating portion configured to releasably couple to the seating pin. In certain approaches, the latch is configurable to a first position and second position. For example, in the first position the seating portion of the latch is coupled to the seating pin, such that the first distal grip end and second distal grip end are spaced apart at a first distance. In the second position, the seating portion is spaced away from the seating pin, such that the closing force of the compression device reduces the first distance.

In certain approaches, first jaw of the retrieval system includes a curved portion between the first distal grip end and a first proximal end of the first jaw. The second jaw includes a curved portion between the second distal grip and a second proximal end of the second jaw. In certain embodiments, the first jaw includes a stationary handle at the first proximal end, and the second jaw includes an actuating handle at the second proximal end. The stationary handle includes a first gripping surface, and the actuating handle includes a second gripping surface. In certain embodiments, the actuating handle includes an upper surface shaped to mate with a lower surface of the stationary handle.

In certain embodiments, the compression device of the retrieval system is a spring. The spring includes a first leg coupled to the first jaw and a second leg coupled to the second jaw. In certain embodiments, the first pivot joint of the retrieval system is a first pin, and the second pivot joint is a second pin. The pivot portion of the latch is a circular-like shape, which is positioned around the second pivot joint. In certain approaches, the seating portion of the latch includes a notch, and the notch rests on the seating pin in the first position.

In certain embodiments, the systems, devices, and methods described herein include a first distal grip end with a first textured gripping surface and a second distal grip end with a second textured gripping surface. The first distal grip end has a first inner step edge, and the second distal grip end has a second inner step edge.

In certain aspects, methods are provided for retrieving an object. The method includes, providing a retrieval system having a first jaw with a first grip end, a second jaw with a second grip end, a latch coupled to the first jaw, and a compression device configured to apply a closing force between the first jaw and the second jaw. The method includes pivoting the second jaw relative to the first jaw to a first position to form a first space such that the first grip end and second grip end are spaced apart at a first distance. In certain approaches, the method includes coupling the latch to the second jaw to maintain the first position. The method includes positioning the retrieval system near an object such that the object is within the first space, and adjusting the position of the retrieval system relative to the object such that the latch contacts the object, thereby releasing the latch from the second jaw. The compression device applies a closing force to reduce the first distance such the first grip end and second grip end contact the object in a gripping position.

In certain approaches, the methods described herein include grasping a stationary handle of the first jaw, grasping a pivoting handle of the second jaw, and pulling the pivoting handle toward the stationary handle to pivot the second jaw to the first position. In certain approaches, the methods described herein include coupling a telescoping pole to a proximal end of the retrieval system, extending the telescoping pole, and holding the telescoping pole to position the retrieval system. In certain embodiments, the methods include releasing first jaw and the second jaw from the gripping position by pivoting the second jaw relative to the first jaw, thereby releasing the object from the retrieval system.

Variations and modifications of these embodiments will occur to those of skill in the art after reviewing this disclosure. The foregoing features and aspects may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 is a perspective view of a disc retriever with a golf disc; and

FIG. 2 depicts a perspective view of a golf disc retriever in an open position; and

FIG. 3 depicts a side view of a disc retriever in the jaws open position; and

FIG. 4 illustrates a bottom view of a retriever in the jaws open position; and

FIG. 5 depicts a side view of a golf disc retriever in a closed position; and

FIG. 6 depicts a cross-sectional view from the distal end of the jaws looking into a disc retriever in the jaws open position; and

FIG. 7 depicts and illustrative view of an extendable pole for a retrieval system; and

FIG. 8 is a side view of a disc retriever attached to an extendable pole, with the retriever in an open position and a golf disc at an initial point of engagement; and

FIG. 9 is a side view of a disc retriever attached to an extendable pole, with the retriever gripping a golf disc.

### DETAILED DESCRIPTION

To provide an overall understanding of the systems, devices, and methods described herein, certain illustrative embodiments will be described. Although the embodiments and features described herein are specifically described for use in connection with retrieving a golf disc, it will be understood that all the components, connection mechanisms, adjustable systems, manufacturing methods, and other features outlined below may be combined with one another in any suitable manner and may be adapted and applied to other retrieval systems, applications, and procedures, including, but not limited to, picking up objects on the ground, retrieving litter or contaminated objects in a sanitary manner, picking fruit, retrieving objects from a shelf, retrieving objects while sitting or lying down, retrieving or maneuvering objects that are very hot or very cold, retrieving objects for forensic purposes without contaminating the objects (e.g., to avoid fingerprints), or any other retrieving or adjusting of objects, which cannot or should not be reached by hand.

Variations and modifications of these embodiments will occur to those of skill in the art after reviewing this disclosure. The foregoing features and aspects may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented.

Disclosed herein are systems, devices, and methods for retrieving objects, and in particular, golf discs, at a distance beyond arm's reach. The retrieval systems and devices described herein are easily and quickly assembled and disassembled, and then readily fit into or on a disc golf bag or other sack or back pack. The systems, devices, and methods provide a clamping golf disc retriever for the retrieval of golf discs that are otherwise beyond reach. In certain approaches, the systems, devices, and methods described herein may include one or more multi-member extendable poles that can expand to achieve a length greater than the compacted length and an attaching gripping or clamping device whose jaws are employed to obtain a secure, positive, firm ensnarement of the golf disc.

In certain aspects, the systems, methods, and devices include a retrieval system having a first jaw with a first distal grip end, and a second jaw with a second distal grip end. The second jaw is coupled to the first jaw with a first pivot joint at a position proximal to the first distal grip end and proximal to the the second distal grip. The systems, methods, and devices include a compression device coupled to the first jaw and the second jaw. The compression device is configured to apply a closing force between the first jaw and the second jaw. In certain approaches, the retrieval system includes a seating pin coupled to the second jaw. In certain embodiments, the retrieval system includes a latch. The latch has a pivot portion rotatably coupled to a second pivot joint at the first jaw, and a seating portion configured to releasably couple to the seating pin. In certain approaches, the latch is configurable to a first position and second position. For example, in the first position the seating portion of the latch is coupled to the seating pin, such that the first distal grip end and second distal grip end are spaced apart at a first distance. In the second position, the seating portion is spaced away from the seating pin, such that the closing force of the compression device reduces the first distance.

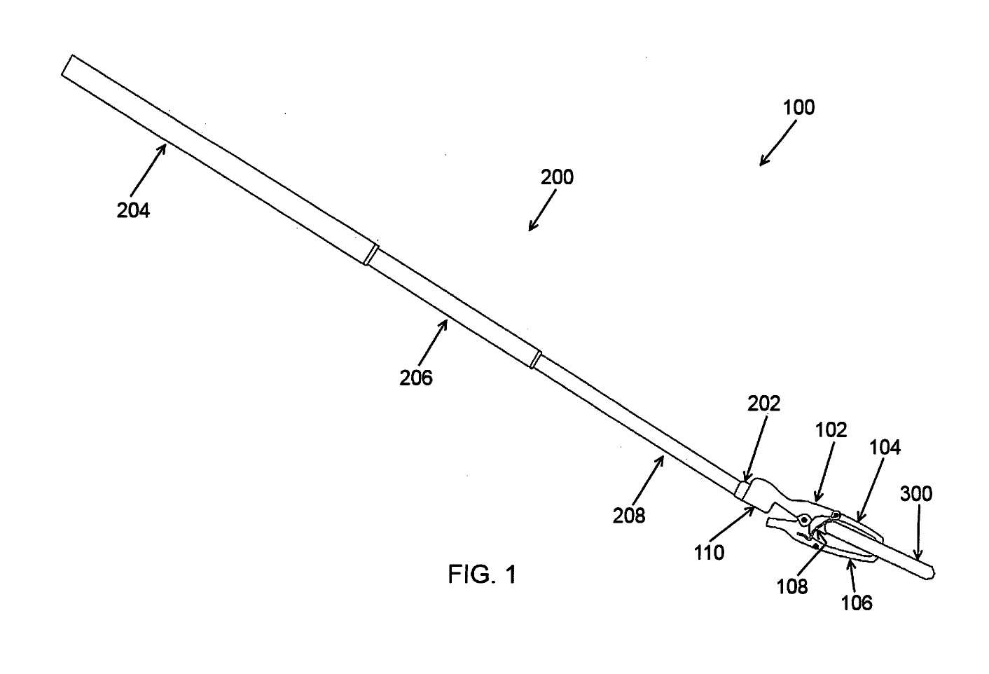

FIG. 1 depicts a disc retriever 100. The disc retriever 100 includes a clamp 102 with a first jaw 104 and a second jaw 106. As depicted, in certain approaches, first jaw 104 and second jaw 106 are positioned to clamp a golf disc 300. The disc retriever 100 includes a latch 108, which pivots to allow the disc retriever 100 to be in an open position or a closed position, as will be described in greater detail below. In certain approaches, the proximal portion 110 of clamp 102 is coupled to a distal portion 202 of a pole 200. In certain embodiments, the clamp 102 and pole 200 are removably coupled, for example, with a threaded coupling. In certain approaches, clamp 102 and pole 200 are permanently coupled. In certain embodiments, pole 200 is extendable. For example, pole 200 may be a telescoping pole with a plurality of telescoping portions 204, 206, and 208. Although three telescoping portions are depicted, any number of telescoping portions may be used. Additionally or alternatively, disc retriever 100 may include multiple poles 200. For example, a first pole may couple to a second pole to further extend the length of the system 100. An extendable, modular pole system may allow system 100 to remain compact, but provide the ability to reach very far distances.

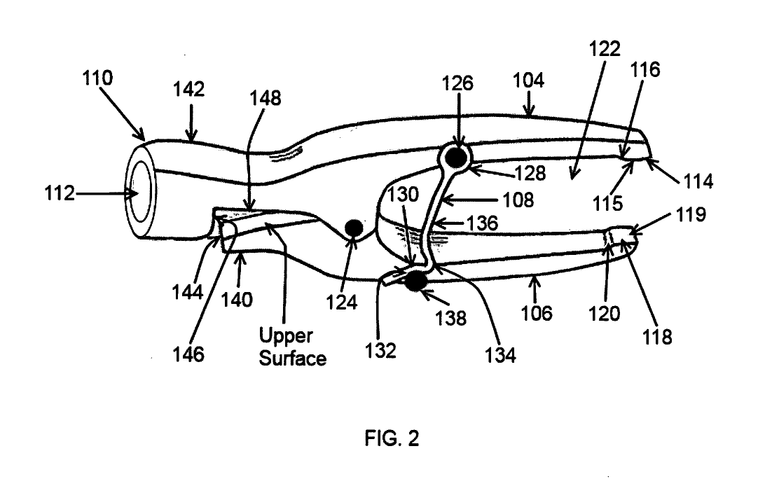

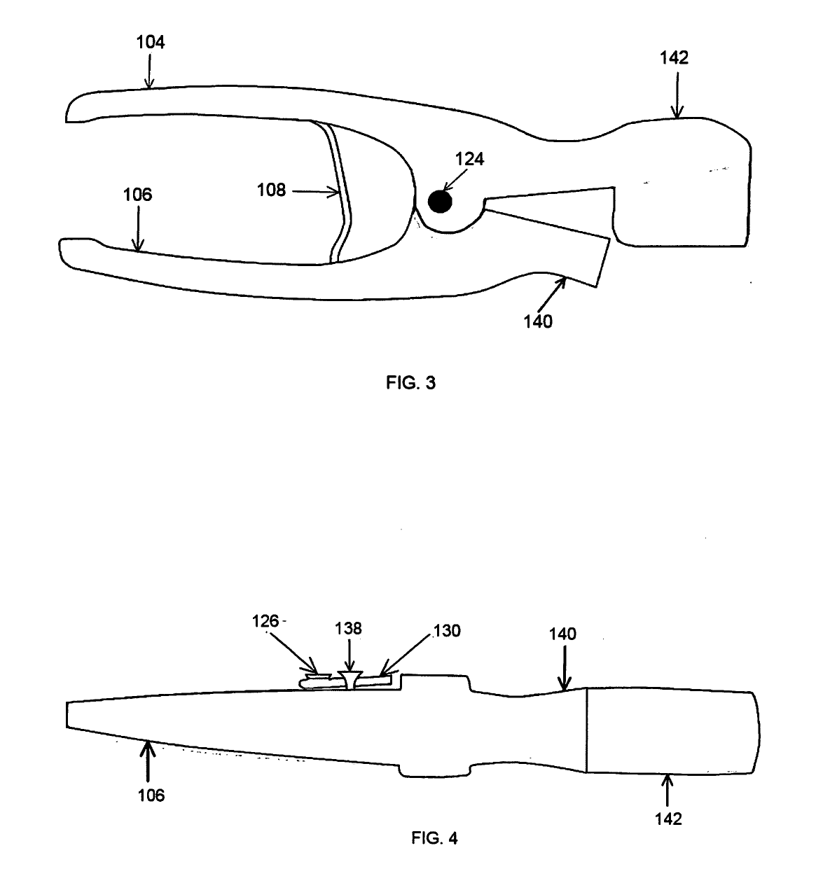

FIG. 2, FIG. 3, and FIG. 4 depict golf disc retriever clamp 202 in an open position. Specifically, FIG. 2 depicts a perspective view of golf disc retriever clamp 202 in an open position, FIG. 3 depicts a side view of golf disc retriever clamp 202 in the open position, and FIG. 4 depicts a bottom view of golf disc retriever clamp 202 in the jaws open position. Clamp 102 includes first jaw 104 and second jaw 106.

In certain embodiments, second jaw 106 is coupled to first jaw 104 with a pivot joint 124. In certain approaches, pivot joint 124 is a pin. Additionally or alternatively, pivot joint 124 may be a different type of connect, which allows second jaw 106 to move or pivot relative to first jaw 104. For example, pivot joint 124 may be a hinge. First jaw 104 may be curved or have a curved portion. Similarly, second jaw 106 may be curved or have a curved portion. For example, first jaw 104 and second jaw 106 may arc outwardly from each other to form an inner space 122. First jaw 104 and second jaw 106 may arc outwardly from pivot joint 124.

First jaw 104 includes a first grip end 114, and second jaw 106 includes a second grip end 118. In certain approaches, first grip end 114 has a textured surface 115, and second grip end 118 has a textured surface 119. For example, textured surfaces 115 and 119 may include raised bumps, grooves, chevrons, or other patterns and surface design. In certain approaches, grip ends 114 and 116 are formed from a material with a durometer or hardness, which is softer than a golf disc. The softer durometer provides increased gripping, and also prevents scratching, marring or otherwise injuring the golf disc. The softer durometer also provides increased gripping capabilities, in addition to that provided by the compression device or spring described in further detail below.

First grip end 114 may include a first edge 116 to form a first lip. Similarly, second grip end 118 may include a second edge 120 to form a second lip. In certain approaches, first edge 116 and second edge 120 extend at a 90 degree angle from the jaw to match the angle of the golf disc, when it is positioned within the jaws, as described in further detail below. These grip ends 114 and 118 are particularly helpful, for example, if the golf disc is temporarily held back during retrieval by a branch or other obstacle. The grip ends 114 and/or 118 may be positioned to contact a raised lip of a golf disc to adjust, loosen, or reposition the golf disc for retrieval.

Clamp 102 includes a latch 108 coupled to the first jaw 104 at a second pivot joint 126. In certain approaches, second pivot joint 126 is a pin. Latch 108 includes a pivot portion 128, which couples to second pivot joint 126. In certain approaches, pivot portion 128 is approximately circular or circular-like, and is positioned around the pivot joint 126. Latch 108 is coupled to pivot joint 126 such that it can rotate or pivot about pivot joint 126. In certain approaches, latch 108 is permanently coupled to the pivot joint 126.

Latch 108 includes a shaft portion 136, which extends from the pivot portion 128 and is approximately straight. Extending from the shaft portion 136 is a bend 134, which curves outward toward the distal end of clamp 102. From the bend 134, the latch 108 includes a seating portion 130, which has a notch 132. In certain approaches, latch 108 has a plurality of notches 132, such that the the distance “d” between the first grip end 114 and the second grip end 118 can be varied. Second pivot joint 126 is affixed to the first jaw 104 such that it is distal to a seating pin 138. Latch 108 can pivot, such that the notch 132 of seating portion 130 can rest upon seating pin 138.

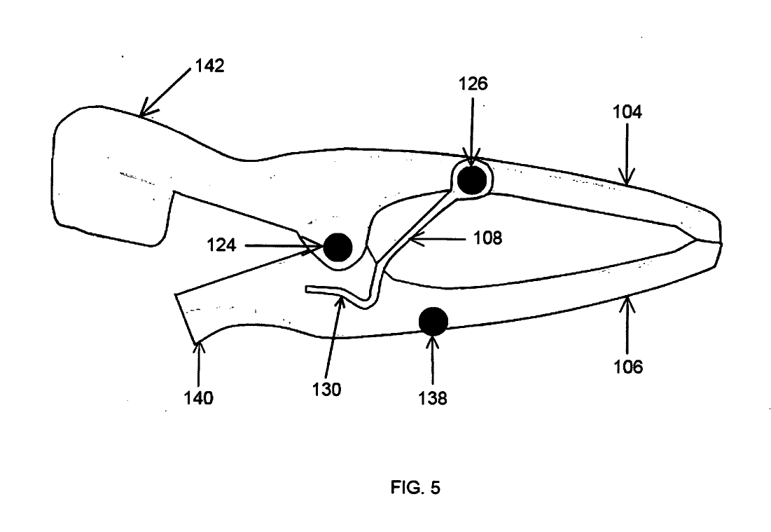

When latch 108 is positioned to rest on seating pin 138, first jaw 104 and second jaw 106 are spaced apart at a distance “d.” The depth of notch 132 is designed to reliably maintain the first jaw 104 and second jaw 106 in an open position, yet require only minimal lateral pressure to release the seating portion 130 from seating pin 138 when the golf disc or other object contacts the latch 108. Upon sufficient contact, latch 108 pivots proximally. This release or unseating of seating portion 130 from the seating pin 138 allows such first jaw 104 and second jaw 106 to close and secure the disc as further described below, and depicted in FIGS. 5, 8, and 9.

Clamp 102 includes a raised portion 150, which blocks latch 108 from swinging proximally past pivot joint 124. In certain approaches, raised portion 150 is a part of first jaw 104. In certain approaches, raised portion is a part of second jaw 106. In certain approaches, raised portion 150 is a part of first jaw 104 and second jaw 106. Raised portion 150 is raised at least partially around the housing of pivot joint 124. Raised portion 150 restricts the arc of rotation of latch 108, which aids in easily and rapidly engaging latch 108 into the seated position to hold first jaw 104 and second jaw 106 open. Additionally, the seating portion 130 of latch 108 has sufficient length, such that latch 108 cannot rotate distally past seating pin 138. In this way, latch 108 is only able to pivot, at most, between pivot joint 124 and seating pin 138.

In certain embodiments, first jaw 104 includes a stationary handle 142 at a proximal end 110. Additionally or alternatively, second jaw 106 includes an actuating or pivoting handle 140. A user can grasp stationary handle 142 and actuating handle 140 and pull them together, thereby opening clamp 102 by separating first grip end 114 and second grip end 118. The user may then position latch 108 such that the notch 132 of seating portion 130 rests on seating pin 138. In certain approaches, the stationary handle 142 includes a lower surface 148 and an inner surface 146, which is continuous with lower surface 148, but angled. For example, inner surface 146 may be orthogonal to lower surface 148. This configuration forms an open area, in which handle 140 can be positioned when the clamp 102 is open. For example, upper surface 152 of handle 140 may be approximately parallel with lower surface 148 of handle 142, and end surface 144 of handle 140 may be approximately parallel with inner surface 148. In this way, a sleek exterior line is created when the clamp 102 is in an open position, which minimizes the risk of snagging on obstacles between the player and the golf disc.

Actuating handle 142 and stationary handle 140 are contoured to provide a user with a comfortable grip upon the device. For example, actuating handle 142 and stationary handle 140 may have curves portions. The length of the stationary handle 140 extends approximately the length of an adult hand.

The golf disc retriever 100 includes a connector 112 at a proximal end 110 of the clamp 112. In certain approaches, a pole, such as pole 200, is coupled to connector 112. For example, connector 112 may include female threads, which couple to male threads at an end of a pole, such as coupling portion 212 of pole 200. For example, FIG. 1 depicts a clamp 102 coupled to pole 200. Additionally or alternatively, other coupling means may be used, including, but not limited to, adhesives, epoxies, friction fit or tight fit coupling, magnets, bayonet mounts, latches, stop pins, quick-release button connectors, and locking cams. First jaw 104 and second jaw 106 are thereby made stationary by their attachment to pole 200, which is held firmly by the user at proximal end 210 for positioning clamp 102 to retrieve an object.

In certain approaches, the width of the clamp 102, for example, as seen in FIG. 4, is less than two inches. This compact design allows access to the golf disc if it is lodged in a difficult to reach location, such as a briar patch. The narrow design is also space-saving when the retrieval system 100 or clamp 102 is stored in a golf disc bag.

FIG. 5 depicts a side view of a golf disc retriever in a closed position. As shown, the seating portion 130 of latch 130 is not resting on the seating pin 138, but is positioned between the seating pin 138 and the pivot joint 124. A compression device, for example compression 160, provides a closing force to close first jaw 104 and second jaw 106. In the depicted example, first grip end 114 and second grip end 118 are touching. In certain approaches, first jaw 104 and second jaw 106 partially close, but grip ends 114 and 118 do not touch. For example, this configuration may be useful when gripping an objection of a known size, particularly if the object is delicate or could be damaged if too much force is applied to grip.

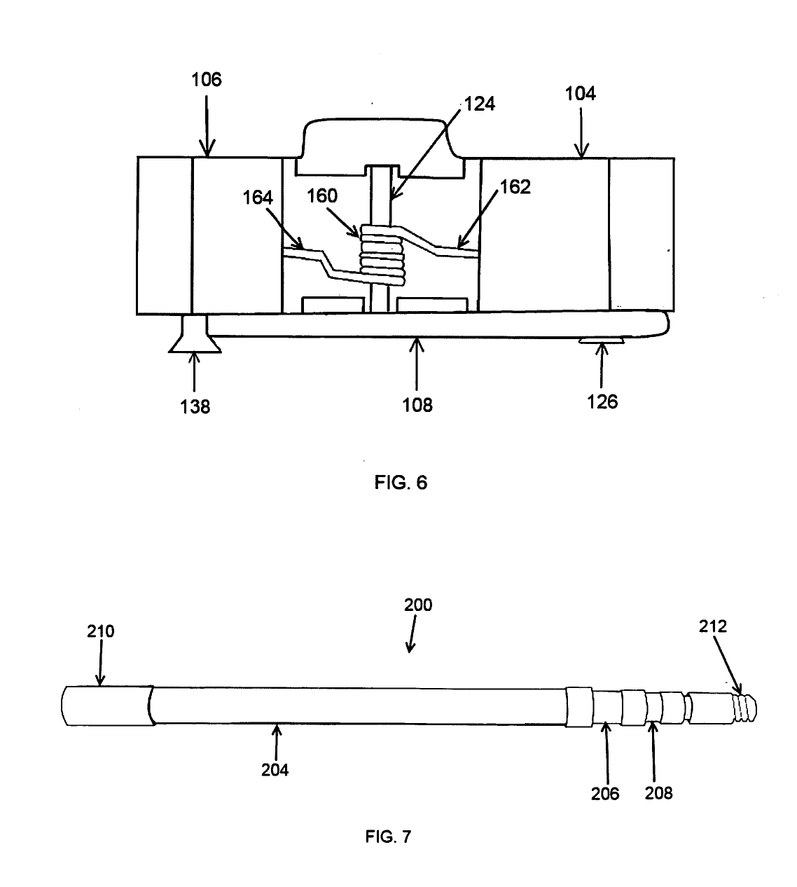

FIG. 6 depicts a cross-sectional view from the distal end of the jaws looking into clamp 102 in the jaws open position. Clamp 102 includes a compression device 160 with a first leg 162 coupled to stationary handle 142, and a second leg 164 coupled to actuating handle 140. Legs 162 and 164 are biased to exert pressure, in an outward direction, on each handles 140 and 142. Accordingly, compression device 160 applies a closing force between first jaw 104 and second jaw 106 such that clamp 102 tends towards the closed configuration when latch 108 is not resting on seating pin 138. Additionally or alternatively, when latch 108 is positioned to rest on seating pin 138 such that first jaw 104 and second jaw 106 are open, compression device 160 provides sufficient force to hold latch 108 in place on the seating pin.

In certain approaches, compression device 160 is a spring. The tension of the spring, such as compression device 160, is sufficient to secure a golf disc or other object, and retrieve it even against some degree of resistance or drag caused by the golf disc coming into contact with branches, rocks or other obstructions. However, the tension is also sufficiently low such that a user or player can easily disengage the clamp 102. For example, if clamp 102 accidentally closes on a branch or other stationary object, the user may pull backward such that object forces open the jaw 104 and jaw 106 from the inside. The tension is also restrained to prevent an injury to a person if the mechanism accidentally closes upon a person's finger or other body part. Additionally or alternatively, the tension is sufficiently low such that the user can easily open clamp 102 by hand by gripping handle 142 and handle 140 to pivot second jaw 106 relative to first jaw 104 as described previously. Compression device 160, including legs 162 and 164 are housed inside the clamp 102 to prevents fouling from leaves, branches or other debris. In certain approaches, compression device 160 wraps around pivot joint 124.

FIG. 7 depicts and illustrative view of a pole 200 for a retrieval system, such as retrieval system 100 or clamp 102. In certain embodiments, pole 200 is extendable. For example, pole 200 may be a telescoping pole with a plurality of telescoping portions 204, 206, and 208. Although three telescoping portions are depicted, any number of telescoping portions may be used. Additionally or alternatively, disc retriever 100 may include multiple poles 200. For example, a first pole may couple to a second pole to further extend the length of the system 100. An extendable, modular pole system may allow system 100 to remain compact, but provide the ability to reach very far distances. In certain approaches, pole 200 can be extended to multiple lengths, for example, from a first length to a second length, and to a third length.

In certain embodiments, pole 200 includes a distal coupling portion 212. Distal coupling portion 212 may include threads, which couple to connector 112 of clamp 102. Additionally or alternatively, other coupling means may be used, including, but not limited to, adhesives, epoxies, friction fit or tight fit coupling, magnets, bayonet mounts, latches, stop pins, quick-release button connectors, and locking cams. In certain approaches, a plurality of poles 200 may be used. For example, coupling portion 212 of a first pole 200 may couple to a proximal coupling portion 214 at a proximal end 210 of a second pole 200. The distal coupling portion 212 of the second pole 200 may then couple to clamp 102. Proximal coupling portion 214 may include threads for coupling to distal coupling portion 212 of a different pole. Additionally or alternatively, other coupling means may be used, including, but not limited to, adhesives, epoxies, friction fit or tight fit coupling, magnets, bayonet mounts, latches, stop pins, quick-release button connectors, and locking cams. Any suitable number of poles 200 may be coupled together to obtain a length required to reach and retrieve the golf disc.

In certain approaches, pole 200 is formed from materials with a sufficient tensile strength, thickness, and circumference so as to be able to comfortably support and hold a golf disc above the ground when a plurality of poles 200 are to reach approximately 15 feet in length. Additionally or alternatively, poles 200 are constructed to be sufficiently lightweight such that a single person can hold and maneuver system 100. Pole 200 may be a telescoping pole with a plurality of telescoping portions 204, 206, and 208. For example, pole 200 may be extended by using a twisting motion with one hand twisting clockwise at the collar of one member (204, 206, and 208) and the other hand twisting counter-clockwise at the proximal base of the next member. In certain approaches, pole 200 includes other locking and unlocking mechanisms between telescoping portions 204, 206, and 208. For example, locking cams can be loosed to allow extension of a member, locked to hold the member in place, and then unlocked to return to a shorter, more compact total length of pole 200. Additionally or alternatively, other coupling means may be used, including, but not limited to, quick-release button connectors, friction fit or tight fit coupling, magnets, bayonet mounts, latches, and stop pins.

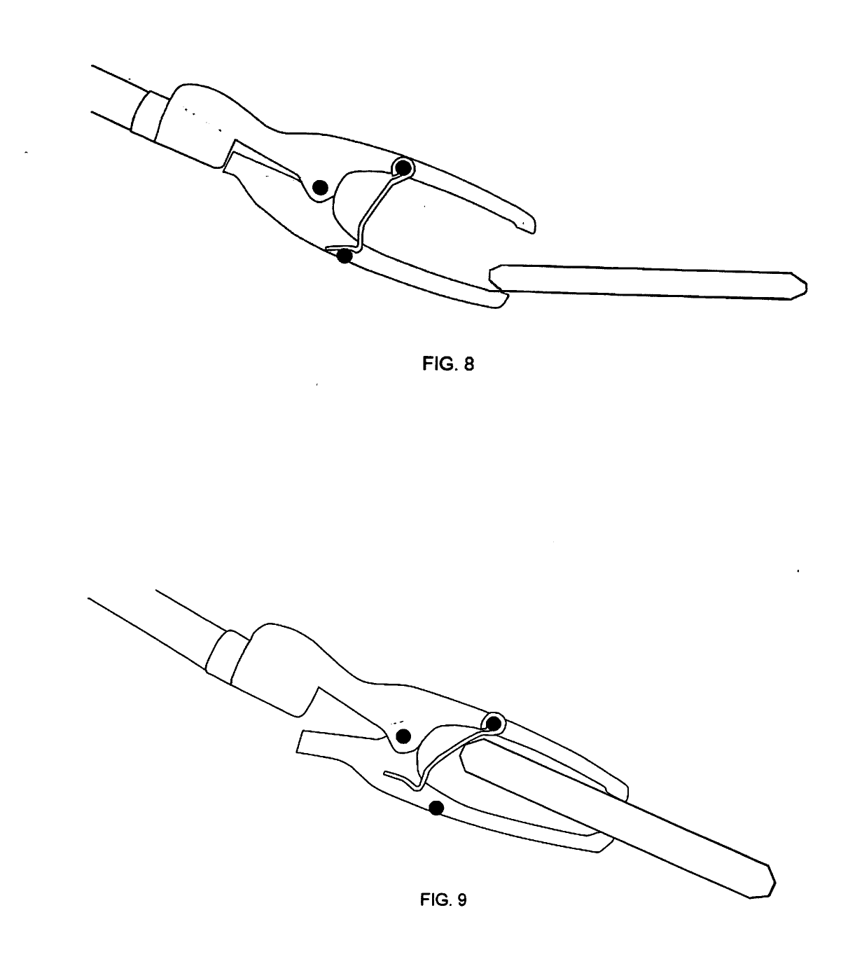

The systems, devices, and methods described herein may be used for retrieving an object, such as disc 300. FIG. 8 depicts disc retriever 100 with clamp 102 in an open position as it is positioned to approach golf disc 300 at an initial point of engagement. In certain approaches, the method includes, providing a retrieval system 100 having a first jaw 104 with a first grip end 114, a second jaw 106 with a second grip end 118, a latch 108 coupled to the first jaw 104, and a compression device 160 configured to apply a closing force between the first jaw 104 and the second jaw 106. A user may pivot the second jaw 106 relative to the first jaw 104 to a first position to form a first space 122 such that the first grip end 114 and second grip end 118 are spaced apart at a first distance “d.” In certain approaches, the methods includes coupling the latch 108 to the second jaw 106 to maintain the first position. For example, the seating portion 130 of latch 108 may be positioned on seating pin 138.

A user may position the retrieval system 100 near an object, such as disc 100, such that the object is within the first space 122. For example, as depicted in FIG. 8, grip end 118 is positioned under disc 300. In certain approaches, a user may adjust the position of retrieval system 100 relative to the object such that the latch contacts the object, thereby releasing the latch from the second jaw. The compression device 160 applies a closing force to reduce the first distance “d” such the first grip end 114 and second grip end 118 contact the object in a gripping position. FIG. 9 is a side view of a disc retriever attached to an extendable pole, with the retriever gripping a golf disc.

In certain approaches, stationary handle 140 and first jaw 104 are positioned dorsally, while actuating handle 142 and second jaw 106 are positioned ventrally. This positioning precludes premature release of the disc 300 in the event that downward pressure upon the clamp 102 is applied by the player. In a reverse formation, the downward pressure could cause disc 300 to press forcefully against the second jaw 106, thereby opening the jaws 104 and 106 to release the disc 300. When stationary handle 140 and first jaw 104 are in the dorsal position, any upward pressure by disc 300 upon first jaw 104 does not lead to opening of the jaws 104 and 106.

In certain approaches, the distance between release latch 108 and the grip ends 116 and 118 is equal to the distance between the outer edge of a golf disc, such as disc 300, and the center point of the disc. This allows for a weight balanced point of contact with disc 300 or other object. Furthermore, clamping disc 300 approximately at the center provides a maximal amount of room for grip ends 116 and 118 to remain in contact with the disc 300 should grip ends 116 and 118 slide across disc 300 due to the disc 300 being momentarily held back during the retrieval. For example, disc 300 may hit an obstacle such as a branch or rock while being retrieved.

In certain approaches, a user grasps stationary handle 142 of the first jaw 104, grasps pivoting or actuating handle 140 of the second jaw 106, and pulls actuating handle 140 toward stationary handle 142 to pivot the second jaw 106 to the open position. In certain approaches, a user couples a telescoping pole 200 to a connector 112 at proximal end 110 of the retrieval system 100. The user may extend pole 200, and then hold the pole to position the retrieval system. After retrieving an object, such as disc 300, a user may release first jaw 104 and second jaw 106 from the gripping position by pivoting second jaw 106 relative to first jaw 104, thereby separating grip ends 114 and 118 to release the object from retrieval system 100.

The foregoing is merely illustrative of the principles of the disclosure, and the systems, devices, and methods can be practiced by other than the described embodiments, which are presented for purposes of illustration and not of limitation. It is to be understood that the systems, devices, and methods disclosed herein, while shown for use in retrieving a golf disc, may be applied to systems, devices, and methods to be adapted and applied to other retrieval systems, applications, and procedures, including, but not limited to picking up objects on the ground, sanitary retrieval of litter or contaminated objects, picking fruit, retrieving objects from a shelf, retrieving objects while sitting or lying down, safely retrieving or maneuvering objects that are very hot, collection of objects for forensic purposes, or any other retrieval or adjustment of objects, which cannot or should not be reached by hand.

Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein. All references cited herein are incorporated by reference in their entirety and made part of this application.

1. A retrieval system, comprising:
a first jaw, having a first distal grip end;
a second jaw, having a second distal grip end, wherein the second jaw is coupled to the first jaw with a first pivot joint at a position proximal to the first distal grip end and proximal to the second distal grip;
a compression device coupled to the first jaw and the second jaw, wherein the compression device is configured to apply a closing force between the first jaw and the second jaw;
a seating pin coupled to the second jaw; and
a latch comprising a pivot portion rotatably coupled to a second pivot joint at the first jaw, and a seating portion configured to releasably couple to the seating pin, wherein the latch is configurable to a first position and second position, the first position having the seating portion coupled to the seating pin, such that the first distal grip end and second distal grip end are spaced apart with a first distance, and a second position having the seating portion spaced away from the seating pin, such that the closing force of the compression device reduces the first distance.

2. The retrieval system of claim 1, wherein the first jaw includes a curved portion between the first distal grip end and a first proximal end of the first jaw, and wherein the second jaw includes a curved portion between the second distal grip and a second proximal end of the second jaw.

3. The retrieval system of claim 2, wherein the first jaw includes a stationary handle at the first proximal end, and the second jaw includes an actuating handle at the second proximal end.

4. The retrieval system of claim 3, wherein the stationary handle includes a first gripping surface, and the actuating handle includes a second gripping surface.

5. The retrieval system of claim 4, wherein actuating handle includes an upper surface shaped to mate with a lower surface of the stationary handle.

6. The retrieval system of claim 1, wherein the compression device is a spring.

7. The retrieval system of claim 6, wherein the compression device includes a first leg coupled to the first jaw and a second leg coupled to the second jaw.

8. The retrieval system of claim 1, wherein the first pivot joint is a first pin, and the second pivot joint is a second pin.

9. The retrieval system of claim 8, wherein the pivot portion is a circular-like shape, which is positioned around the second pivot joint.

10. The retrieval system of claim 9, wherein the seating portion includes a notch, and the notch rests on the seating pin in the first position.

11. The retrieval system of claim 1, wherein the first distal grip end has a first textured gripping surface and the second distal grip end has a second textured gripping surface.

12. The retrieval system of claim 11, wherein the first distal grip end has a first inner step edge, and the second distal grip end has a second inner step edge.

13. The retrieval system of claim 1, further comprising a pole removably coupled to a proximal end of the first jaw.

14. The retrieval system of claim 13, wherein the pole is a telescoping pole.

15. A method for retrieving an object, comprising:
providing a retrieval system having a first jaw with a first grip end, a second jaw with a second grip end, a latch coupled to the first jaw, and a compression device configured to apply a closing force between the first jaw and the second jaw;
pivoting the second jaw relative to the first jaw to a first position to form a first space such that the first grip end and second grip end are spaced apart at a first distance;
coupling the latch to the second jaw to maintain the first position;
positioning the retrieval system near an object such that the object is within the first space; and
adjusting the position of the retrieval system relative to the object such that the latch contacts the object, thereby releasing the latch from the second jaw, and the compression device applies a closing force to reduce the first distance such the first grip end and second grip end contact the object in a gripping position.

16. The method of claim 15, further comprising:
grasping a stationary handle of the first jaw;
grasping a pivoting handle of the second jaw; and
pulling the pivoting handle toward the stationary handle to pivot the second jaw to the first position.

17. The method of claim 16, further comprising:
coupling a telescoping pole to a proximal end of the retrieval system;
extending the telescoping pole; and
holding the telescoping pole to position the retrieval system.

18. The method of claim 17, further comprising:
releasing first jaw and the second jaw from the gripping position by pivoting the second jaw relative to the first jaw, thereby releasing the object from the retrieval system.
